(19) United States
(12) Patent Application Publication
(10) Pub. No.: US 2009/0079180 A1
(43) Pub. Date: Mar. 26, 2009

(54) SYSTEM AND METHOD FOR BINDING AND STORING ARTICLES

(76) Inventor: Dalia Z. Zuniga, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/237,086

(22) Filed: Sep. 24, 2008

Related U.S. Application Data
(60) Provisional application No. 60/974,676, filed on Sep. 24, 2007.

(51) Int. Cl. B42D 1/00; B42D 3/00

(52) U.S. Cl. 281/21.1; 281/31

(57) ABSTRACT

A system and device to facilitate binding and storage of loose articles for later viewing and use thereof is provided, including at least one attachment strip having a free edge and opposing first and second faces, a border formed along a side of the attachment strip and having a plurality of openings, adhesive applied to an adhesive area on at least one of the opposing first and second faces of each attachment strip, and a view window area formed between the adhesive area and the border that is transparent to enable viewing therethrough. Preferably a removable liner covers the entire adhesive area prior to its use, after which the liner is removed and the adhesive area is applied directly to the article to be stored in the binding device. The binding device can then be retained in a conventional binder, such as a three-ring binder.

### BACKGROUND

1. Technical Field

The present disclosure is directed to the storage and retrieval of documents and other articles and, more particularly, to a binding strip that is attachable to the edge of a document or article to enable storage in a binder or the like.

2. Description of the Related Art

Organizing and storing loose documents and other articles, such as news clippings, correspondence, and photographs, is desirable in order to facilitate protection and easy retrieval of the same. One well-known method utilizes a transparent sleeve having a top or side opening in which to insert an article. Some sleeves have holes provided along one side for use with a ring binder to retain and store the transparent sleeves.

One disadvantage of this method is the amount of space these sleeves take up as well as the additional weight they provide when multiple sleeves are used. For example, 50 to 100 of these sleeves stacked on top of each other add one-half inch or more of thickness to a binder. In addition, these sleeves and other similar storage pockets add substantial weight to the binder. The use of these sleeves is not required in all situations, and hence there is a need for a binding system that enables storing of loose articles and documents in binders without requiring the use of such sleeves and pockets.

### BRIEF SUMMARY

The present disclosure is directed to a device and system for collecting, binding, and displaying loose articles, including a system for securing the device in a manner that organizes, protects, and presents the articles for viewing, marking, and other use.

In accordance with one embodiment of the present disclosure, a device is provided for binding loose articles, the device including at least one attachment strip having a free edge and opposing first and second faces; a border formed along a side of the attachment strip and having a plurality of openings; adhesive applied to an adhesive area on at least one of the opposing first and second faces of each at least one attachment strip; a view window area formed between the border and the adhesive area that is transparent to enable viewing therethrough; and a removable liner covering the entire adhesive area.

In accordance with another embodiment of the present disclosure, what is provided is a system for organizing articles, the system including a binder and a device for attachment to at least one of the articles, the device including at least one attachment strip having a free edge and opposing first and second faces; a border formed along a side of the attachment strip and having a plurality of openings; adhesive applied to an adhesive area on at least one of the opposing first and second faces of each at least one attachment strip; a view window area formed between the border and the adhesive area that is transparent to enable viewing therethrough; and a removable liner covering the entire adhesive area.

In accordance with another embodiment of the present disclosure, a binding strip is provided that includes a plurality of attachment strips, each attachment strip having a free edge and opposing first and second faces; a border having a plurality of openings, each of the plurality of attachment strips extending from the border to position the attachment strips in aligned parallel relationship; an adhesive applied to an adhesive area on at least one of the first and second faces of each attachment strip; a view window area formed between the border and the adhesive area to enable viewing by a user therethrough; and a removable backer covering the entire adhesive area.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric exploded view of a system for binding and storing loose articles in accordance with the present disclosure;

FIG. 2 is an isometric view of a device for binding articles formed in accordance with the present disclosure;

FIG. 3 is an isometric view of a binding device for loose articles formed in accordance with another embodiment of the present disclosure;

FIGS. 4A-4C illustrate front, top, and front views, respectively, of various features of the system of the present disclosure; and

FIGS. 5A-5C are front, top, and side views, respectively, of a carrying case for use with the system of FIG. 1.

### DETAILED DESCRIPTION

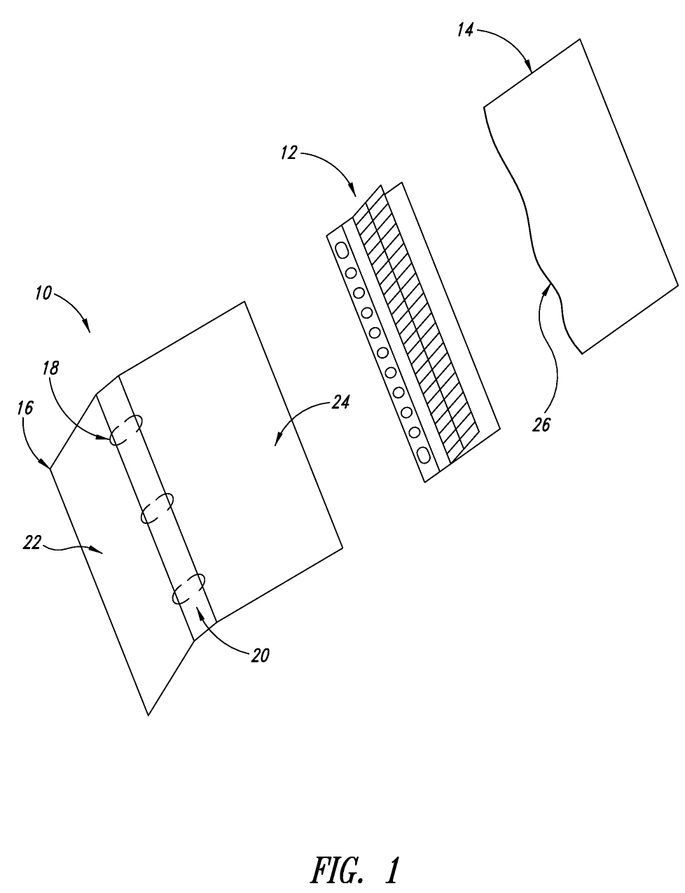

Referring initially to FIG. 1, shown therein is one embodiment of a system 10 for binding articles formed in accordance with the present disclosure. More particularly, in this embodiment the system includes a device 12 for binding loose articles 14 in a conventional three-ring binder 16. Because these three-ring binders are readily commercially available, they will not be described in detail herein. Briefly, the binder 16 includes three openable and closable binder rings 18 arranged along a spine 20 of the binder 16. Front and back covers 22, 24 extend from the spine 20 and are closable about the spine 20 to enclose the rings 18. It is to be understood that while a three-ring binder is illustrated, the present system can be utilized with binders using more or less than three rings or using other types of binding mechanisms, including clamps, and the like.

The system is designed to retain articles 14, which can include letters, photographs, newspaper clippings, pages torn from books and magazines, and the like. Articles and objects that are substantially flat and have the ability to be adhered to conventional adhesive can be used with the system. Thus, in the system illustrated in FIG. 1, the article 14 is shown having one edge 26 in an uneven state, as it would appear when torn from a magazine. It is this portion of the article 14 adjacent the edge 26 that is bound by the binding device 12.

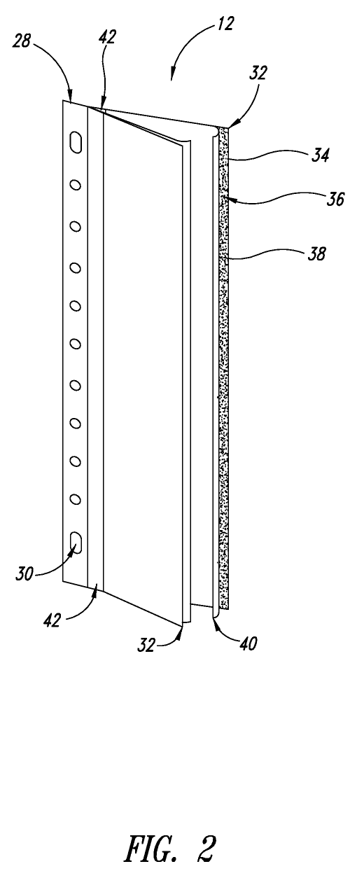

Referring to FIG. 2, the binding device 12 is shown to include a border 28 formed along one side and having a plurality of openings 30 formed therethrough. Ideally, the openings are sized, shaped, and positioned to be received over the rings 18 in the binder 16. A plurality of openings 30 are provided in order to allow the binding device 12 to be used with binders of different ring configurations, e.g., two rings, four rings, spiral, etc. Because the border 28 will be subjected to a substantial amount of use when mounted in the binder 16, including pulling on the rings 18, it is preferred that the border be reinforced, such as with extra-thick material or a reinforcement layer on one or both sides thereof.

Extending from the border 28 are a pair of attachment strips 32 that have a free edge 34 on one end and the other end attached to or integrally formed with the border 28 such that each attachment strip 32 extends from the border 28 as pages in a book. In other words, the opening between the attachment strips 32 stops at the border 28 such that a stop is formed by intersection of the strips 32 with the border 28. The strips 32 may be integrally formed with the border or one or more strips bonded to or adhered to the border 28 to extend therefrom.

Each attachment strip 32 has an adhesive area 36 in which is applied adhesive 38 that is covered by a lining or backer 40. The adhesive area occupies a portion of the attachment strip 32 so as to form a transparent view window 42 between the adhesive area 36 and the border 28. The view window 42 is preferably formed of transparent material to enable viewing by a user therethrough to align the article 14 with the binding strip 12 when it is attached to the attachment strips 32, as will be described in more detail hereinbelow.

Ideally, in this embodiment the adhesive area 36 extends the entire height of the attachment strip 32 and from the free edge 34 to the view window 42. Similarly, the lining 40 is sized to match the size and shape of the adhesive area 36 so as not to overlap the view window 42 and obstruct viewing through the view window 42. Various other configurations are possible, however, including strips of adhesive or patches of adhesive formed in the adhesive area.

Preferably, each attachment strip 32 is formed from the lightest transparent material available to reduce weight and size. Preferably it is formed of linen-free and acid-free material, and the adhesive 38 is permanently formed in the adhesive area 36. Many adhesives are available, and the selection of the type of adhesive can be made in accordance with the desired use of the binding strip 12. For example, a low-tack adhesive can be used to allow articles 14 to be repeatedly inserted and removed from the binding device 12. A high-tack adhesive will provide more permanent bonding such that the article 14 cannot be taken out of the binding strip 12 without causing damage to the article 14.

As shown in FIG. 2, the adhesive area 36 is formed on only one of the mutually opposing faces of each attachment sheet 32. In this case, the adhesive area is formed on the face of each attachment sheets 32 such that the adhesive areas 36 are in face-to-face relationship with one another. In this way, when the liners 40 are removed and an article 14 is inserted between the attachment strips 32, both of the attachment strips 32 will be adhered to the opposing sides of the article 14. It is to be understood that only one attachment strip need be used with each article such that one attachment strip 32 can have one article attached to one face thereof, thus holding two articles with one binding strip 12. Alternatively, one article can be attached to each of the opposing faces of the same attachment strip 32. Hence, many combinations are available for use as determined by the needs of the user.

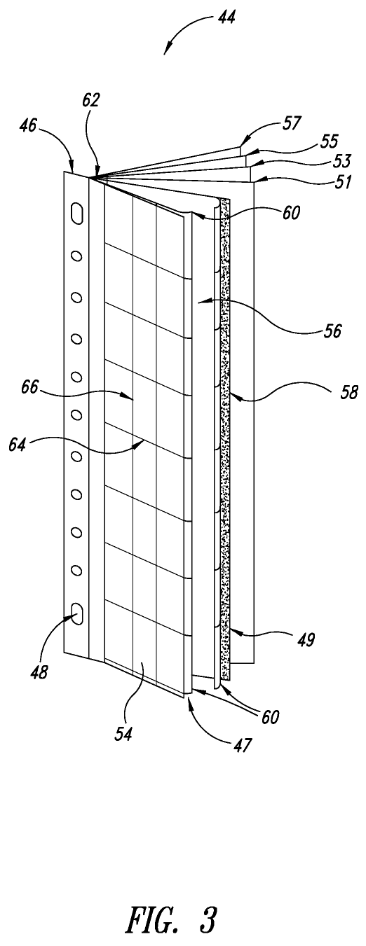

Turning next to FIG. 3, shown therein is a binding device 44 having a border 46 formed along one side with a plurality of openings 48 similar to the openings 30 shown in FIG. 2. Six attachment strips 47, 49, 51, 53, 55, and 57 are shown depending from the border 46 in a manner substantially identical to or similar to that described above. Each attachment strip includes opposing parallel faces 54, 56 on which are formed respective adhesive areas 58, of which a representative sample is shown only on the center attachment strip 49. Adhesive backers 60 are applied over each of the adhesive areas 58. As shown in this embodiment, each attachment strip 47, 49, 51, 53, 55, and 57 is preferably formed of transparent material such that a viewing window 62 is formed between the adhesive area 58 and the border 46. In addition, each of the removable liners or backers 60 have a plurality of horizontal and vertical lines 64, 66, respectively, that form a grid visible through the transparent attachment strip to facilitate alignment of the article 14 with the device 44 prior to applying the adhesive area 58 to the article 14. While a grid pattern is shown, it is to be understood that other indicia can be used to aid in visually aligning the article 14 through the view window 62 with the border 46 and the adhesive area 58. In addition, while the gridlines 64, 66 can be printed or formed on the view window directly, this is not preferred because it would interfere with viewing of an underlying object.

With this embodiment of the present disclosure, multiple pages can be held by a single binding device 44. This enables a user to bind into one easily removable binding device 44 articles or documents that are related to one another.

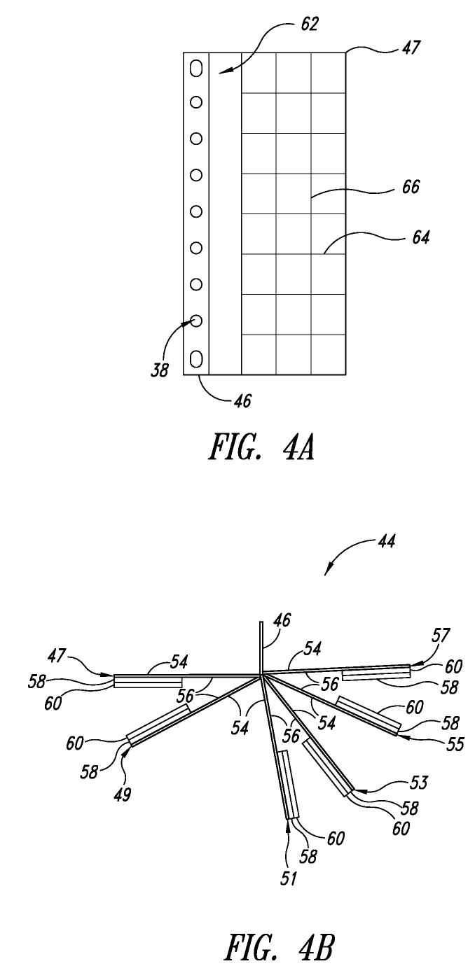

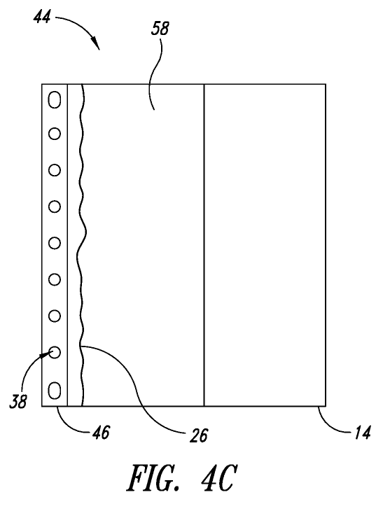

FIGS. 4A and 4B are front and top views, respectively, of the binding device 44 of FIG. 3 in which all six of the attachment strips 47, 49, 51, 53, 55, and 57 are shown from a top view with their respective opposing faces 54, 56 and corresponding adhesive areas 58 with removable liners 60.

FIG. 4C illustrates the article 14 after it has been adhered between attachment strips 47 and 49. It can be seen that the uneven edge 26 is adjacent to the border 46 and the remainder of the document or article 14 extends beyond the adhesive area 58 of the first attachment strip 47.

In use, the binding device 44 is either allowed to remain in the binder 16 or is taken out and the backer 60 is removed from one adhesive area 58 while the attachment strip 50 is positioned away from the attachment strip 48. The article 14 is brought into position between the attachment strips 47 and 49 so that the edge 26 is seen through the view window 62 in abutting relationship with the border 46. The horizontal and vertical indicia 64, 66, respectively, aid the user in aligning the article 14 with the device 44. Once the user is satisfied that the article 14 is correctly positioned, the attachment strip 49 is brought into engagement with the article 14 so that the adhesive area 58 is in binding contact with the article 14. The backer 60 on the first attachment strip 47 can also be removed and the attachment strip 47 bound to the article 14 with its respective adhesive area. In this way the article 14 is securely held on both sides by the attachment strips 47 and 49. Alternatively another article 14 can be positioned between the attachment strip 47 and the first article 14, and adhered to only the attachment strip 47. Thus, with the three attachment strips shown in FIG. 3, up to six separate articles can be adhered to the single binding strip 44. This assumes that each article is sized to completely cover the entire adhesive area 58 on each attachment strip 47. Articles of a smaller dimension may be adhered to the same attachment strip, thus allowing more that six articles to be retained in a single binding device 44.

It is to be understood that the size and shape of the attachment strips may vary as may the size and placement of the adhesive areas 58 on each attachment strip. For example, smaller adhesive areas may be used and multiple small adhesive areas may be placed in different positions on each face of each attachment strip. Also, the indicia 64, 66 can be printed on both sides or one side of each of the backers 60 so that they can be visible from both directions of the backer 60.

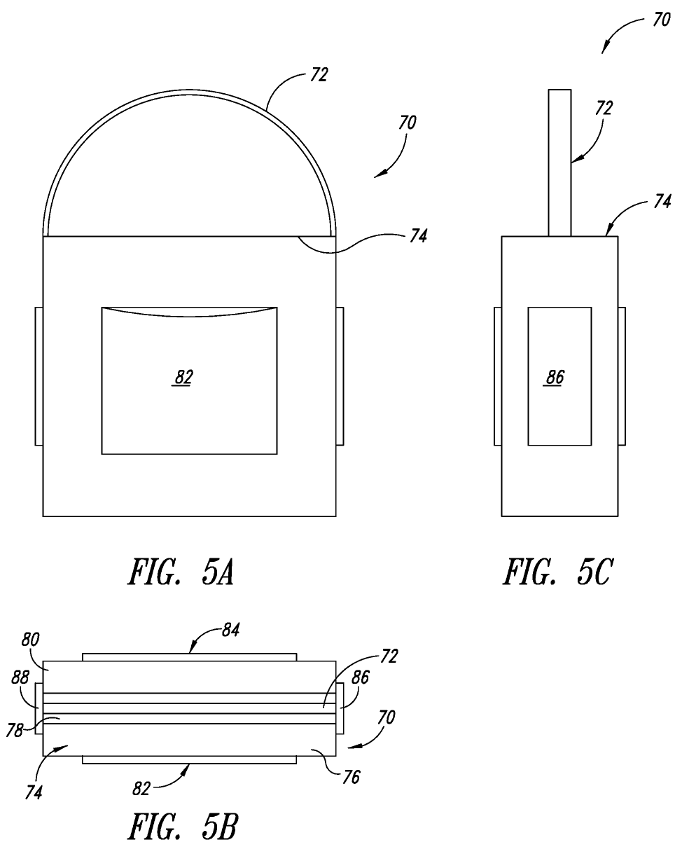

Turning next to FIGS. 5A-5C, shown therein is a carrying case having a carrying handle 72 for use in storing and transporting the system of FIG. 1, including binders, binding devices 12, 46, and articles 14. Tools may also be carried in the carrying bag 70 or in pockets as described below.

In one embodiment, the carrying case 70 has an open top 74, although the top can be covered by a flap or shut with the use of a zipper or other fastening means. In this embodiment, the top 74 is open and the interior of the bag 70 is divided into three sections, a first section 76, which can be used for storing articles to be bound, a middle section 78, which can be used for storing the magazines, newspapers, or other sources for the articles 14 to be bound, and a third section 80 for storing the articles with the binding devices attached thereto. Storage can also be provided for the binder, although this will add weight and take up space and is not preferred in this embodiment. The exterior of the carrying case 70 can include first and second side pockets 82, 84, which can be used for storing the binding devices, tools, trash, and the like. End pockets 86, 88 can be provided for storing tools as well, such as scissors, and personal communication devices, such as a cell phone, and other electronic equipment, including a PDA, flashlight, and personal articles such as water and sunglasses. Additional pockets can be provided on the outside of these pockets or adjacent to them for storing other optional articles, including highlighters, pens, pencils, and the like.

Additional enhancements can also be provided, such as a corner indexing system in which a triangle-shaped gusset can be applied to the corners of each article retained in a binding device. These indexing corners can have different colors to signify a particular type of article. Hence, it is to be understood that the present disclosure is limited not by the scope of the representative embodiments described herein but only the scope of the following claims and their equivalents.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device to facilitate binding and storage of loose articles, the device comprising:
at least one attachment strip having a free edge and opposing first and second faces;
a border formed along a side of the attachment strip opposite the free edge and having a plurality of openings;
adhesive applied to an adhesive area on at least one of the opposing first and second faces of each at least one attachment strip;
a view window area formed between the border and the adhesive area that is transparent to enable viewing therethrough; and
a removable liner covering the entire adhesive area.

2. The device of claim 1 wherein the removable liner comprises a plurality of indicia to facilitate alignment of the article with the device.

3. The device of claim 1 wherein each at least one attachment strip is formed of flexible, transparent material.

4. The device of claim 1 wherein the adhesive area extends an entire height of the attachment strip.

5. A system for organizing articles, comprising:
a binder;
a device for attachment to at least one of the articles, the device comprising:
at least one attachment strip having a free edge and opposing first and second faces;
a border formed along a side of the attachment strip and having a plurality of openings;
adhesive applied to an adhesive area on at least one of the opposing first and second faces of each at least one attachment strip;
a view window area formed between the border and the adhesive area that is transparent to enable viewing therethrough; and
a removable liner covering the entire adhesive area.

6. The system of claim 5, further comprising a carrying case adapted to hold the binder.

7. The system of claim 6 wherein the carrying case comprises a plurality of pockets.

8. A device for securing one or more loose articles, the device comprising:
a plurality of attachment strips, each attachment strip having a free edge and opposing first and second faces;
a border having a plurality of openings, each of the plurality of attachment strips extending from the border to position the attachment strips in aligned parallel relationship;
an adhesive applied to an adhesive area on at least one of the first and second faces of each attachment strip;
a view window area formed between the border and the adhesive area to enable viewing by a user therethrough; and
a removable backer covering the entire adhesive area.

9. The device of claim 8 wherein the adhesive area is formed on each of the first and second faces of each attachment strip, the attachment strips arranged to extend from the border and position each adhesive area on adjacent attachment strips in a face-to-face relationship.

10. The device of claim 9 wherein the removable backer comprises a plurality of indicia to facilitate alignment of the article with the device.
